(19) United States
(12) Patent Application Publication
(10) Pub. No.: US 2026/0046217 A1
(43) Pub. Date: Feb. 12, 2026

(54) MANAGING DISTRIBUTED NETWORK FUNCTIONS IN A CORE NETWORK

(71) Applicant: Nokia Technologies Oy, Espoo (FI)

(72) Inventors: Parsa RAJABZADEH, Massy (FR); Abdelkader OUTTAGARTS, Massy (FR); Fabio GIUST, Munich (DE); Tejas SUBRAMANYA, Munich (DE)

(21) Appl. No.: 18/998,697

(22) PCT Filed: Aug. 9, 2022
(86) PCT No.: PCT/EP2022/072348

§ 371 Date: Jan. 27, 2025

(51) Int. Cl. H04L 41/16; H04L 41/14

(52) U.S. Cl. CPC H04L 41/16; H04L 41/145

(57) ABSTRACT

The discussed solution provides a framework for managing distributed network functions in a core network. The frame-work may use multi-agent federated reinforcement learning to orchestrate the distributed network functions in the core network. The framework may comprise a server network function responsible for providing a global machine learning model to one or more local network functions and managing the local network functions using a feedback mechanism. The local network functions may perform local training and apply the feedback from the server network function.

### TECHNICAL FIELD

Various example embodiments generally relate to the field of telecommunication systems. In particular, some example embodiments relate to a solution for managing distributed network functions in a core network.

### BACKGROUND

The number of connected devices to the internet has increased gradually in recent years. New mobile communication network generations provide more reliable real-time access and significantly less latency compared to earlier generations. To enhance the Quality of Experience (QoS) and Quality of Service (QoS) for the end-users, a new network function (NF) named network data analytics function (NWDAF) is defined in the 5G core architecture. The NWDAF is a 3GPP standard method that is responsible for providing machine intelligence in the 5G. NWDAF is able to collect data from any NF, Operation administration and management (OAM) systems, or even Users equipment on the edges.

There can be multiple NWDAFs in the 5G core to provide information for the NFs, Application functions (AF), or OAMs. These NWDAFs may be located on the edges near core network functions. The network functions could subscribe to the edge NWDAFs that generate analytics and provide ultra-low latency use cases for improving QoE and QoS.

One possible solution for orchestrating multiple NWDAF instances is to apply centralized learning in the context of the core network. Upon this approach, edge NWDAFs may pre-process their local data sets in a parallel manner. Afterward, the edge NWDAFs may send their pre-processed data and their provided analytics to one defined central NWDAF. The central NWDAF acts like a server and processes the collected data from the local NWDAFs and comes up with the fully trained model. Despite the advantages of centralized learning algorithms in handling large amounts of data, there are many drawbacks in the solutions, for example:
Latency: Sending all data to the central NWDAF and processing the overall data on the central NWDAF takes a significant time in each iteration.
Low security and privacy: Local datasets are exposed to the server. In addition, sharing local datasets between the local agent and the central NWDAF puts the orchestration framework vulnerable against security attacks such as fishing or Fake Data Injection Attack(FDIA).
High implementation cost: Processing all network's data on the server and sending huge amount local data to the server is extremely costly in terms of implementation cost and energy consumption.
Lack of robustness: In the case of unpredictable events the framework would have a disastrous result. Due to lack of control in the learning process.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a multi-agent federated reinforcement learning solution to orchestrate distributed network functions, for example, NWDAFs in a core network. This may enable an efficient architecture implementation. This benefit may be achieved by the features of the independent claims. Further implementation forms are provided in the dependent claims, the description, and the drawings.

According to a first aspect, an apparatus may comprise at least one processor and at least one memory storing instructions that, when executed by the at least one processor, cause the apparatus at least to perform: applying, by a server network function, an iterative distributed machine learning model training process between the server network function and at least one local network function, the server network function initially providing the at least one local network function with an initial global machine learning model to be trained by the at least one local network function by respective local data of the at least one local network function; obtaining, from each local network function of the at least local network function, new parameter data associated with a trained initial global machine learning model trained by each local network function in its latest iteration; updating the initial global machine learning model at least partly based on the new parameter data obtained from the at least one local network function; generating, at least partly based on the updated initial global machine learning model, feedback data to the at least one local network function, the feedback data of a local network function reflecting individual performance of the local network function in its latest iteration; and transmitting the feedback data to the at least one local network function.

In an example embodiment of the first aspect, the instructions, when executed by the at least one processor, cause the apparatus to perform: transmitting to each local network function of the least one network function an initialization message to start the iterative distributed machine learning model training process, the initialization message transmitted to a local network function comprising encryption parameter data defined for the local network function for encrypting the parameter data sent by the local network function; and decrypting the new parameter data obtained from a local network function using the encryption parameter data associated with the local network function.

In an example embodiment of the first aspect, the instructions, when executed by the at least one processor, cause the apparatus to perform: generating, at least partly based on individual behaviour of the at least one local network function, weight data associated with the at least one local network function, the weight data providing a weight value for each local network function of the at least one local network function for weighing the new parameter data associated with the local network function.

In an example embodiment of the first aspect, the instructions, when executed by the at least one processor, cause the apparatus to perform: aggregating the new parameter data obtained from the at least one local network function using weighted federated averaging and the current weight data associated with the at least one local network function.

In an example embodiment of the first aspect, the instructions, when executed by the at least one processor, cause the apparatus to perform: receiving an evaluation result from each local network function of the at least one local network function, the evaluation result indicating performance of the local network function on its local data; and using the evaluation results in generating the feedback data.

In an example embodiment of the first aspect, the server network function comprises a network data analytics function.

According to a second aspect, an apparatus may comprise at least one processor and at least one memory storing instructions that, when executed by the at least one processor, cause the apparatus at least to perform: applying, by a local network function, an iterative distributed machine learning model training process between a server network function and the local network function, an initial global machine learning model being initially obtained from the server network function; obtaining local data; obtaining feedback data from the server network function, the feedback data reflecting performance of the local network function in its latest iteration; and training the initial global machine learning model at least partly based on the feedback data and the local data.

In an example embodiment of the second aspect, the instructions, when executed by the at least one processor, cause the apparatus to perform: receiving, from the server network function, an initialization message to start the iterative distributed machine learning model training process, the initialization message comprising encryption parameter data defined for the local network function; and obtaining new parameter data associated with the trained initial global machine learning model of the local network function; encrypting the new parameter data using the encryption parameter data; and transmitting the encrypted new parameter data to the server network function.

In an example embodiment of the second aspect, the instructions, when executed by the at least one processor, cause the apparatus to perform: evaluating prediction analytics with the local data to provide an evaluation result; and transmitting the evaluation result to the server network function.

In an example embodiment of the second aspect, the instructions, when executed by the at least one processor, cause the apparatus to perform: obtaining new parameter data based on the trained initial global machine learning model; and transmitting the new parameter data to the server network function.

In an example embodiment of the second aspect, the local network function comprises a network data analytics function.

According to a third aspect, a method may comprise applying, by a server network function, an iterative distributed machine learning model training process between the server network function and at least one local network function, the server network function initially providing the at least one local network function with an initial global machine learning model to be trained by the at least one local network function by respective local data of the at least one local network function; obtaining, from each local network function of the at least local network function, new parameter data associated with a trained initial global machine learning model trained by each local network function in its latest iteration; updating the initial global machine learning model at least partly based on the new parameter data obtained from the at least one local network function; generating, at least partly based on the updated initial global machine learning model, feedback data to the at least one local network function, the feedback data of a local network function reflecting individual performance of the local network function in its latest iteration; and transmitting the feedback data to the at least one local network function.

In an example embodiment of the third aspect, the method further comprises transmitting to each local network function of the least one network function, an initialization message to start the iterative distributed machine learning model training process, the initialization message transmitted to a local network function comprising encryption parameter data defined for the local network function for encrypting the parameter data sent by the local network function; and decrypting the new parameter data obtained from a local network function using the encryption parameter data associated with the local network function.

In an example embodiment of the third aspect, the method further comprises generating, at least partly based on individual behaviour of the at least one local network function, weight data associated with the at least one local network function, the weight data providing a weight value for each local network function of the at least one local network function for weighing the new parameter data associated with the local network function.

In an example embodiment of the third aspect, the method further comprises aggregating the new parameter data obtained from the at least one local network function using weighted federated averaging and the current weight data associated with the at least one local network function.

In an example embodiment of the third aspect, the method further comprises receiving an evaluation result from each local network function of the at least one local network function, the evaluation result indicating performance of the local network function on its local data; and using the evaluation results in generating the feedback data.

In an example embodiment of the third aspect, the server network function comprises a network data analytics function.

According to a fourth aspect, a method may comprise applying, by a local network function, an iterative distributed machine learning model training process between a server network function and the local network function, an initial global machine learning model being initially obtained from the server network function; obtaining local data; obtaining feedback data from the server network function, the feedback data reflecting performance of the local network function in its latest iteration; and training the initial global machine learning model at least partly based on the feedback data and the local data.

In an example embodiment of the fourth aspect, the method further comprises receiving, from the server network function, an initialization message to start the iterative distributed machine learning model training process, the initialization message comprising encryption parameter data defined for the local network function; obtaining new parameter data associated with the trained initial global machine learning model of the local network function; encrypting the new parameter data using the encryption parameter data; and transmitting the encrypted new parameter data to the server network function.

In an example embodiment of the fourth aspect, the method further comprises evaluating prediction analytics with the local data to provide an evaluation result; and transmitting the evaluation result to the server network function.

In an example embodiment of the fourth aspect, the method further comprises obtaining new parameter data based on the trained initial global machine learning model; and transmitting the new parameter data to the server network function.

In an example embodiment of the fourth aspect, the server network function comprises a network data analytics function.

According to a fifth aspect, a computer program may comprise instructions which, when executed by an apparatus, cause the apparatus to perform at least the following: applying, by a server network function, an iterative distributed machine learning model training process between the server network function and at least one local network function, the server network function initially providing the at least one local network function with an initial global machine learning model to be trained by the at least one local network function by local data of the at least one local network function; obtaining, from each local network function of the at least local network function, new parameter data associated with a trained initial global machine learning model trained by each local network function in its latest iteration; updating the initial global machine learning model at least partly based on the new parameter data obtained from the at least one local network function; generating, at least partly based on the updated initial global machine learning model, feedback data to the at least one local network function, the feedback data of a local network function reflecting individual performance of the local network function in its latest iteration; and transmitting the feedback data to the at least one local network function.

According to a sixth aspect, a computer program may comprise instructions which, when executed by an apparatus, cause the apparatus to perform at least the following: applying, by a local network function, an iterative distributed machine learning model training process between s server network function and the local network function, an initial global machine learning model being initially obtained from the server network function; obtaining local data; obtaining feedback data from the server network function, the feedback data reflecting performance of the local network function in its latest iteration; and training the initial global machine learning model at least partly based on the feedback data and the local data.

According to a seventh aspect, a computer-readable medium may comprise a program that comprises instructions which, when executed by an apparatus, cause the apparatus to perform at least the following: applying, by a server network function, an iterative distributed machine learning model training process between the server network function and at least one local network function, the server network function initially providing the at least one local network function with an initial global machine learning model to be trained by the at least one local network function by local data of the at least one local network function; obtaining, from each local network function of the at least local network function, new parameter data associated with a trained initial global machine learning model trained by each local network function in its latest iteration; updating the initial global machine learning model at least partly based on the new parameter data obtained from the at least one local network function; generating, at least partly based on the updated initial global machine learning model, feedback data to the at least one local network function, the feedback data of a local network function reflecting individual performance of the local network function in its latest iteration; and transmitting the feedback data to the at least one local network function.

According to an eighth aspect, a computer-readable medium may comprise a program that comprises instructions which, when executed by an apparatus, cause the apparatus to perform at least the following: applying, by a local network function, an iterative distributed machine learning model training process between s server network function and the local network function, an initial global machine learning model being initially obtained from the server network function; obtaining local data; obtaining feedback data from the server network function, the feedback data reflecting performance of the local network function in its latest iteration; and training the initial global machine learning model at least partly based on the feedback data and the local data.

According to a ninth aspect, an apparatus may comprise means for: applying, by a server network function, an iterative distributed machine learning model training process between the server network function and at least one local network function, the server network function initially providing the at least one local network function with an initial global machine learning model to be trained by the at least one local network function by local data of the at least one local network function; obtaining, from each local network function of the at least local network function, new parameter data associated with a trained initial global machine learning model trained by each local network function in its latest iteration; updating the initial global machine learning model at least partly based on the new parameter data obtained from the at least one local network function; generating, at least partly based on the updated initial global machine learning model, feedback data to the at least one local network function, the feedback data of a local network function reflecting individual performance of the local network function in its latest iteration; and transmitting the feedback data to the at least one local network function:

According to a tenth aspect, an apparatus may comprise means for: applying, by a local network function, an iterative distributed machine learning model training process between s server network function and the local network function, an initial global machine learning model being initially obtained from the server network function; obtaining local data; obtaining feedback data from the server network function, the feedback data reflecting performance of the local network function in its latest iteration; and training the initial global machine learning model at least partly based on the feedback data and the local data

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1A illustrates an example of a method according to an example embodiment.

FIG. 1B illustrates an example of a method according to an example embodiment.

FIG. 2 illustrates a flow diagram according to an example embodiment.

FIG. 3 illustrates a flow diagram according to an example embodiment.

FIG. 4 illustrates a flow diagram according to an example embodiment.

FIG. 5A illustrates a sequence diagram according to an example embodiment.

FIG. 5B illustrates a sequence diagram according to an example embodiment.

FIG. 6 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

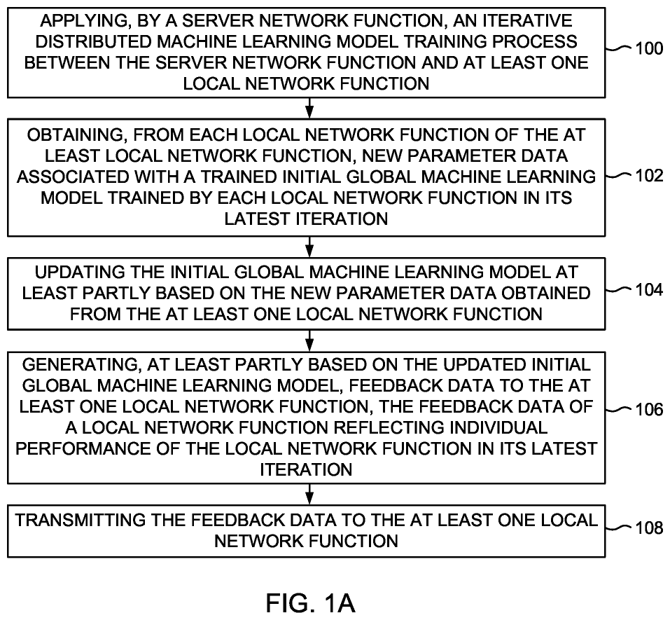

FIG. 1A illustrates an example of a method according to an example embodiment. The example illustrated in FIG. 1A may provide a solution for implementing a distributed network function architecture, for example, an NWDAF architecture. The architecture may apply federated reinforcement learning based distributed NWDAF model training.

At 100 a server network function, for example, a server agent or an aggregator NWDAF, may apply an iterative distributed machine learning model training process between the server network function and at least one local network function. In the iterative distributed machine learning model training process, the server network function initially provides the at least one local network function with an initial global machine learning model to be trained by the at least one local network function by respective local data of the at least one local network function.

At 102 the server network function may obtain from each local network function of the at least local network function new parameter data associated with a trained initial global machine learning model trained by each local network function in its latest iteration.

At 104 the server network function may update the initial global machine learning model at least partly based on the new parameter data obtained from the at least one local network function.

At 106 the server network function may generate, at least partly based on the updated initial global machine learning model, feedback data to the at least one local network function, the feedback data of a local network function reflecting individual performance of the local network function in its latest iteration.

At 108 the server network function may transmit the feedback data to the at least one local network function.

FIG. 1B illustrates a flow diagram according to an example embodiment. The example illustrated in FIG. 1B may provide a solution for implementing a distributed network function architecture, for example, an NWDAF architecture. The architecture may apply federated reinforcement learning based distributed NWDAF model training.

At 110 a local network function, for example, a local agent or a local NWDAF, may apply an iterative distributed machine learning model training process between a server network function and the local network function, an initial global machine learning model being initially obtained from the server network function.

At 112 the local network function may obtain local data.

At 114 the local network function may obtain feedback data from the server network function, the feedback data reflecting performance of the local network function in its latest iteration.

At 114 the local network function may train the initial global machine learning model at least partly based on the feedback data and the local data.

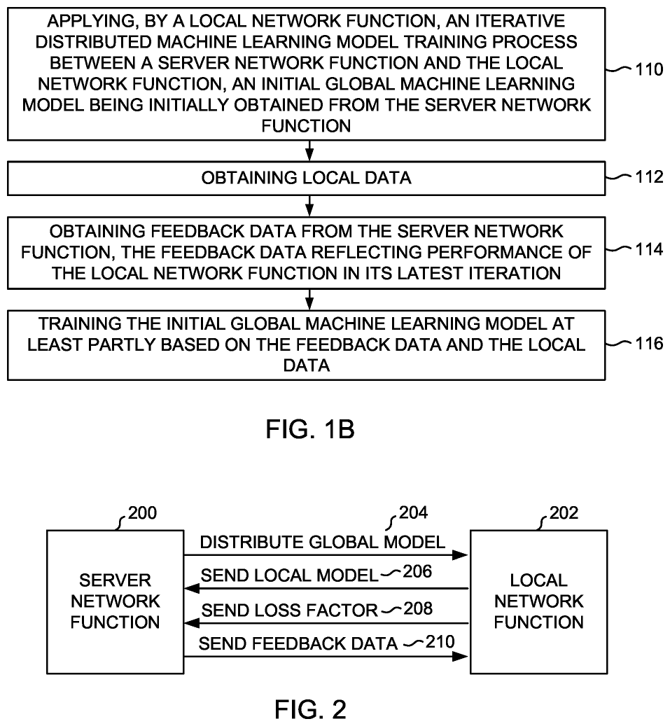

FIG. 2 illustrates a flow diagram according to an example embodiment. The general solution illustrated in FIG. 2 uses multi-agent federated reinforcement learning to orchestrate distributed NWDAFs in core network. The solution may use federated learning in order to process data collected on the edges.

The system may comprise two types of network functions that are coordinating with each other to meet a defined goal:
A server network function 200, for example, a server NWDAF or Aggregator NWDAF may be responsible to provide 204 a global machine learning model and manage the other (local) agents using a feedback mechanism 210.
A local network function 202, for example, a local NWDAF may perform the local training of the global machine learning model and provide 206 local model parameters to the server network function based on its own local dataset. To increase security, the local model parameters may be encrypted before transmission to the server network function. In an example embodiment, a local differential privacy (LDP) may be applied to the local model parameters by the local network function. The local network function may also send 208 a loss factor to the server network function.

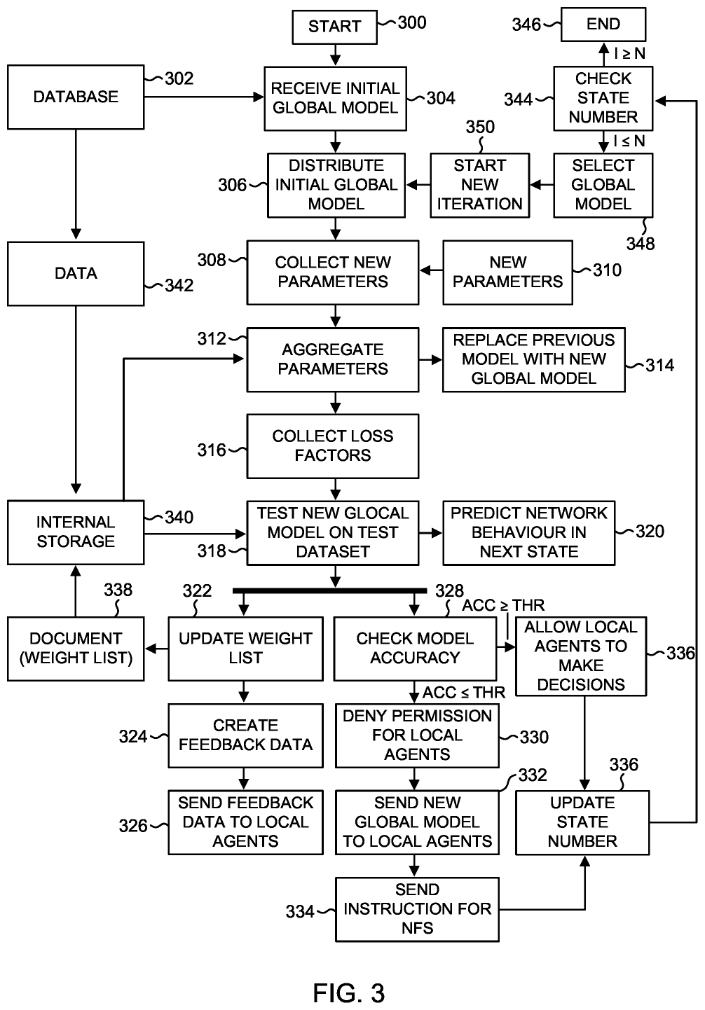

FIG. 3 illustrates a flow diagram according to an example embodiment. The flow diagram illustrated in FIG. 3 shows actions that may be performed by a server network function, for example, a server agent or an aggregator NWDAF.

The process starts at 300 when the first iteration is initiated by the aggregator NWDAF by collecting test data from its own data provider and receiving 304 an initial global model from a database 302, for example, analytics data repository function (ADRF). This operation may be performed just once in the first iteration. The initial global model is then distributed 306 throughout local network functions, for example, local NWDAFs in a core network. In each iteration, the aggregator NWDAF may generate a global model using parameters of the local NWDAFs' models during an aggregation phase. This generated global model may be distributed among the local NWDAFs at the beginning of the next iteration.

At 308 the aggregator NWDAF obtains new parameters 310 from the local NWDAFs and aggregates the obtained parameters. In an example embodiment, the new parameters may have been encrypted by the local NWDAFs. To prepare the updated local parameters (i.e. the new parameters) for the aggregation, the aggregator NWDAF may extract the actual local parameters by cancelling the noise applied by local NWDAFs using, for example, the local differential privacy (LDP) method. The new parameters are then aggregated by using, for example, the weighted federated averaging method. In every iteration the aggregator NWDAF may generate a weight list based on the behaviours of each local NWDAF. The outcome of the aggregation are the new parameters of the new global model, and the previous global model may be replaced with the new global model at 314. The weighted federated averaging may help the multi-agent federated reinforcement learning (FRL) framework to provide a reliable global model by associating a weight to each local NWDAF based on their behaviour. The aggregation may be performed, for example, based on the following formula:

$$w = {\sum }_{𝔫 = 1}^{N} \frac{{n}_{i} \times {w}_{i}}{N}$$

where the w and wᵢ are the new aggregated parameters and transferred parameters of the local NWDAFs. This mechanism may increase the robustness of the multi-agent FRL against unpredictable undesired events. In general, there may be three cases of undesired events which could occur after a considerable time: Security attacks such as the false data injection attack (FDIA), unbalance datasets on the edges, and killed or failed local NWDAF. To avoid these threats affecting the learning process, the aggregator NWDAF may associate weights to the local NWDAFs regarding how much their behaviours are close to the reference desired behaviour. The aggregator NWDAF may then update the weight list at each iteration at 322.

The aggregator NWDAF may also obtain loss factors from the local NWDAFs at 316. The loss factor may inform the aggregator NWDAF about the performance of the local NWDAFs on their local datasets.

At 318 the new global model may be tested with the test dataset collected, for example, from the aggregator NWDAF's data provider. This supervised mechanism helps the system to learn faster and trains more efficiently. In addition, having a reference to compare with the result of the reached global model helps an operator for judging the trustworthiness and performance of the current global model.

At 320 the aggregator NWDAF may provide analytics information about the next state of the core network and predict the network behaviour in the next state.

At 322 the aggregator NWDAF may update the weight list and store the weight list at 338 to an internal storage 340. One benefit of updating the weight list at the end of each iteration is that this approach makes the whole training process more robust against, for example, unbalanced local data sets or false data injection attack (FDIA).

At 324 the aggregator NWDAF may create feedback data to be sent to the local NWDAFs. The local NWDAFs may thus receive feedback data from the aggregator NWDAF based on their individual behaviour in the last iteration. The illustrated solution thus may use feedbacks (rewards) to make the whole learning network to converge to a defined goal. The goal may be to reach accuracy above a defined threshold by evaluating the global model on the test dataset. Further, the feedback data helps the local NWDAFs to improve their accuracy in the their next iteration.

At 326 the feedback data may be sent to the local NWDAFs. The feedback data may be individual for each local NWDAF.

At 328 global model accuracy may be checked. If the accuracy exceeds a threshold accuracy, at 336 the aggregator NWDAF may allow the local NWDADs to make decisions. If the accuracy is below the threshold accuracy, at 330 the aggregator NWDAF may deny permission to make decisions for the local NWDAFs, and at 322 send the new global model parameters to the local NWDAFs.

At 334 the aggregator NWDAF may send instructions for the local NWDAFs and update a state number at 336. At 344 the aggregator NWDAF may check the state number, and if the state number I exceeds a defined state number N, the processing ends at 346. If the state number I is smaller than the defined state number N, the global model is selected at 348 and a new iteration step is started at 350.

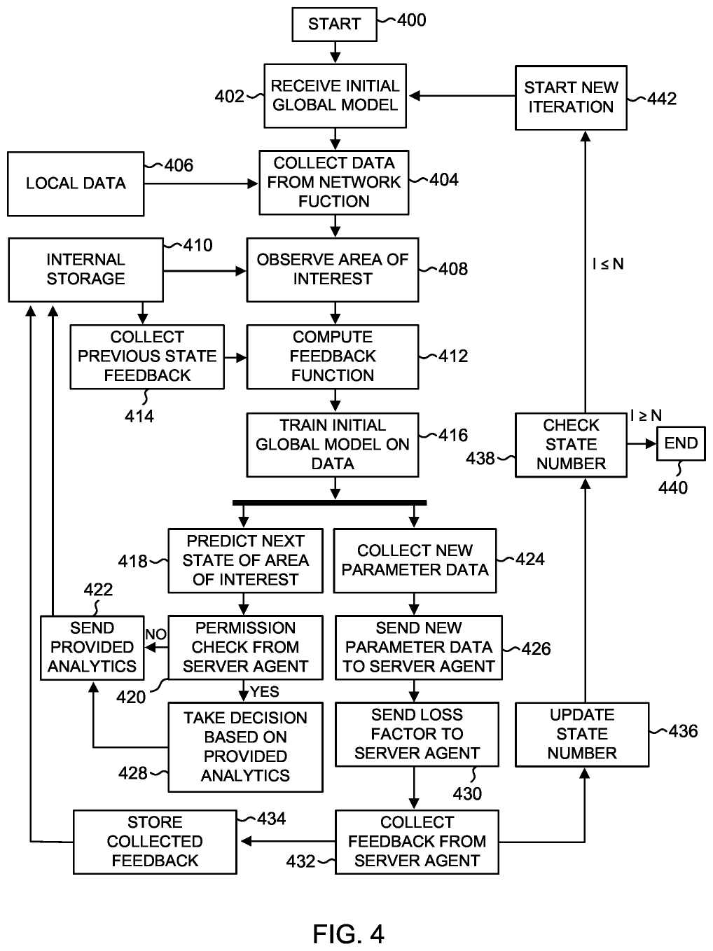

FIG. 4 illustrates a flow diagram according to an example embodiment. The flow diagram illustrated in FIG. 4 shows actions that may be performed by a local network function, for example, a local agent or a local NWDAF.

The process starts at 400 when the local NWDAF receives at 402 an initial global model from the aggregator NWDAF.

At 404 the local NWDAF may obtain local data from from data providers on the edges to train their received model with their local data.

At 408 the local NWDAF may observe an area of interest based on information obtained from an internal storage 410.

At 412 the local NWDAF may compute a feedback function using feedback data collected from the aggregator NWDAF relating to a previous state of the local NWDAF. The feedback data, i.e. the reward, may help the local NWDAF to modify its behaviour in the current iteration. The reward may be computed regarding both the rewards received from the server NWDAF and delayed reward obtained from its area of interest computed by the local NWDAF itself.

At 416 the local NWDAF may train the initial global model at least partly based on the feedback data and the local data 406.

At 418 the local NWDAF may predict the new state of the area of interest and at 420 check whether a permission has been received from the aggregator NWDAF sent at 336. If no permission has been received, at 422 analytics may be sent and stored at the internal storage 410, for example, in order to keep track of the local NWDAF's behaviour in the passage of time.

At 428 the local NWDAF may take a decision based on the provided analytics when the permission has been received from the aggregator NWDAF.

At 424 the local NWDAF may collect new parameter data obtained based on training the initial global model at 416, and send the new parameter data to the aggregator NWDAF at 426.

At 430 the local NWDAF may send an evaluation result, for example, a loss factor to the aggregator NWDAF. The loss factor informs the aggregator NWDAF about the performance of the local NWDAF on its local datasets.

At 432 the local NWDAF may collect feedback from the aggregator NWDAF relating to its latest iteration sent by the aggregator NWDAF at 326, and at 434 store the collected feedback to the internal storage 410 for use in its next iteration and, for example, in order to keep track of the local NWDAF's behaviour in the passage of time.

At 436 the local NWDAF may update a state number I, and at 438 check whether the state number I, and if the state number I exceeds a defined state number N, the processing ends at 440. If the state number I is smaller than the defined state number N, a new iteration step is started at 442.

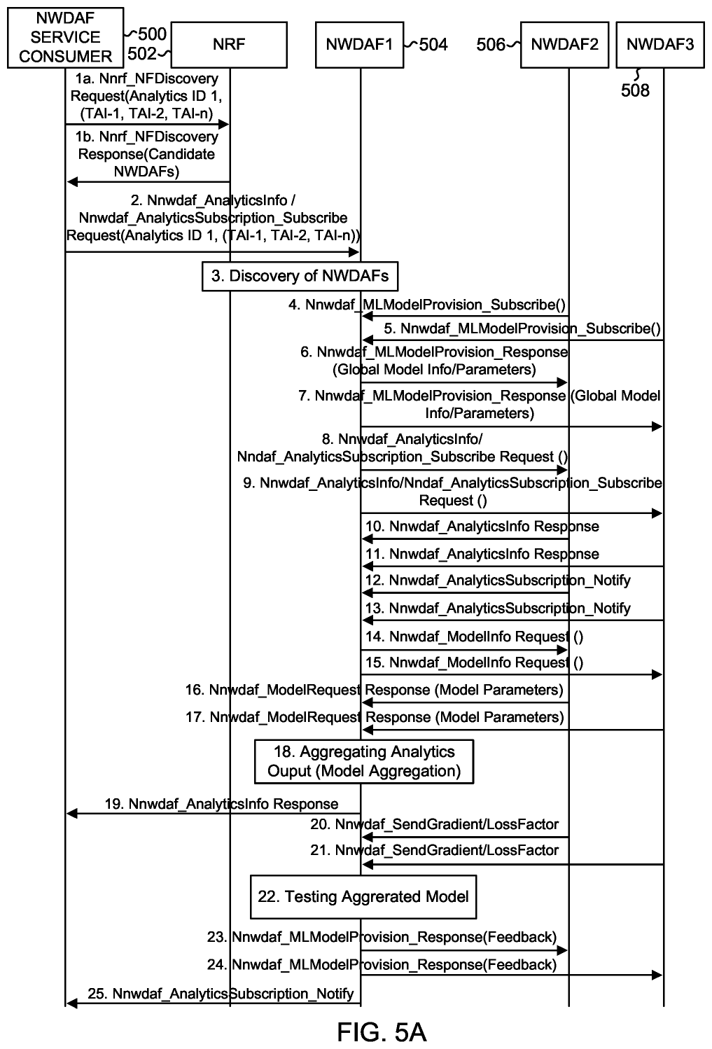

FIG. 5A illustrates a sequence diagram according to an example embodiment for a multi-agent FRL framework in a context of distributed NWDAF architecture in a core network, for example, a 5G core network.

The architecture comprises a NWDAF service consumer 500, a network repository function (NRF) 502, an aggregator NWDAF 504 and two local NWDAFs 506, 508.

At step 1a the NWDAF service consumer 500 initiates its request by sending the NWDAFs discovery request to the NRF 502.

At step 1b the discovery request is responded by the NRF 502 with the elected aggregator NWDAF 504.

At step 2 the NWDAF service consumer 500 sends a subscribe request to the aggregator NWDAF 504.

A discovery of NWDAFs is perform at step 3. FIG. 5B illustrates the discovery process in more detail.

At 510 the aggregator NWDAF is selected, and the aggregator NWDAF 504 starts the discovery process.

At step 3a the aggregator NWDAF 504 sends Nnrf_NFDiscovery Request to the NRF 502 for discovering the local NWDAFs in the network.

At step 3b the discovery request is responded by the NRF 502 including the IDs of the local NWDAFs 506, 508 that are participating in the operation.

At step 3c the aggregator NWDAF 504 sends the NWDAF initiatesFRL_framework message in order to force the local NWDAFs 506, 508 to start the learning process. This message may contain defined encryption data, for example, noises. By receiving these initiate messages, the local NWDAFs 506, 508 can apply the defined noise for protecting their local global model parameters against security attacks, for example, based on the local differential privacy (LDP) method. Each local NWDAF 506, 508 may receive a unique defined noise in order to apply it as a protection to its local global model parameters in later iteration steps.

At 512 a training loop is started with aggregator NWDAF 504 and the local NWDAFs 506, 508.

At steps 4 and 5 the local NWDAFs 506, 508 send the ML_Model_Provision Subscription( ) to the aggregator NWDAF 504 in order to receive the global model parameters and information related to the training process.

At steps 6 and 7 the ML_Model_Provision_Subscription request( ) is responded by the aggregator NWDAF 504 with the ML_Model_Provision Response( ). The response message may contain the global model parameters and information regarding the federated reinforcement learning framework such as determination of the horizontal or vertical federated learning.

At steps 8 and 9 the aggregator NWDAF 504 first sends the Nnwdaf_AnalyticsInfo/Nnwdaf AnalyticsSubscription Subscribe request( ) to the local NWDAFs 506, 508 for subscribing to their analytic service. This message may be sent to retrieve prediction analytics provided by the local NWDAFs 506, 508 after their local training.

At steps 10-13, after the local training at the local NWDAFs 506, 508, the local NWDAFs 506, 508 send the Nnwdaf_AnalyticsInfo response to the aggregator NWDAF 504. The response may comprise the predictive analytics about their area of interest. This response message is followed by the AnalyticsSubscritpion_Notify message.

The local parameters may be collected from the local NWDAFs 506, 508 on the edges. Therefore, at steps 14-15 the aggregator NWDAF 504 sends Nnwdaf_ModelInfo_Request( ) to the local NWDAFs 506, 508 aiming to collect the parameters of the local global models.

At steps 16-17 after receiving the Nnwdaf_ModelInfo_Request( ), the local NWDAFs apply 506, 508 the local differential privacy (LDP) method on their parameters using the defined noise received from the aggregator NWDAF 504 earlier in the initiate FRL framework message. This mechanism may protect the local parameters from security attacks such as phishing attacks At step 18 the aggregator NWDAF 504 starts a global model aggregation procedure. The aggregator NWDAF 504 may generate a new global model using the local parameters received by the local NWDAFs 506, 508. The aggregator NWDAF 504 may also utilize a weighted federated averaging for the model aggregation.

At step 19 the result of the aggregation is sent by the aggregator NWDAF 504 to the service consumer 500 with the Nnwdaf_AnalyticsInfo Response( ). This step may be executed in each iteration of the learning process.

At steps 20-21 after the local training, the local NWDFs 506, 508 evaluate their prediction analytics with their local data set. The result of this evaluation may then be sent to the aggregator NWDAF 504 in the form of a loss factor. This information is carried out by the Nnwdaf_SendGradients/LossFactor message. The loss factor informs the aggregator NWDAF 504 about the performance of the local NWDAFs 506, 508 on their local datasets.

At step 22, when having all of the required information and the new global model, the aggregator NWDAF 504 may test the new aggregated global model on its own test dataset and provide analytics about its area of interest. After training the global model, the aggregator NWDAF 504 may provide a list of feedbacks (rewards) and a list of weights according to the individual behaviour of local NWDAFs 506, 508 in training the global model and the evaluation result of their local model on their local dataset.

At steps 23-24 the feedbacks may be sent by ML_ModelProvisionSubscription_Notify message to the local NWDAFs 506, 508. The feedbacks help the local NWDAFs 506, 508 to improve their accuracy in their next iteration. The aggregator NWDAF 504 may use this feedback to help each of the local NWDAFs 506, 508 to converge to a global defined goal.

At step 25 the aggregator NWDAF 504 may send Nnwdaf_AnalyticsSubscription_Notify message to the NWDAF service consumer 500.

FIGS. 5A and 5B illustrates some examples of signaling messages between the elements. These signaling messages are only examples of possible signaling messages that can be used.

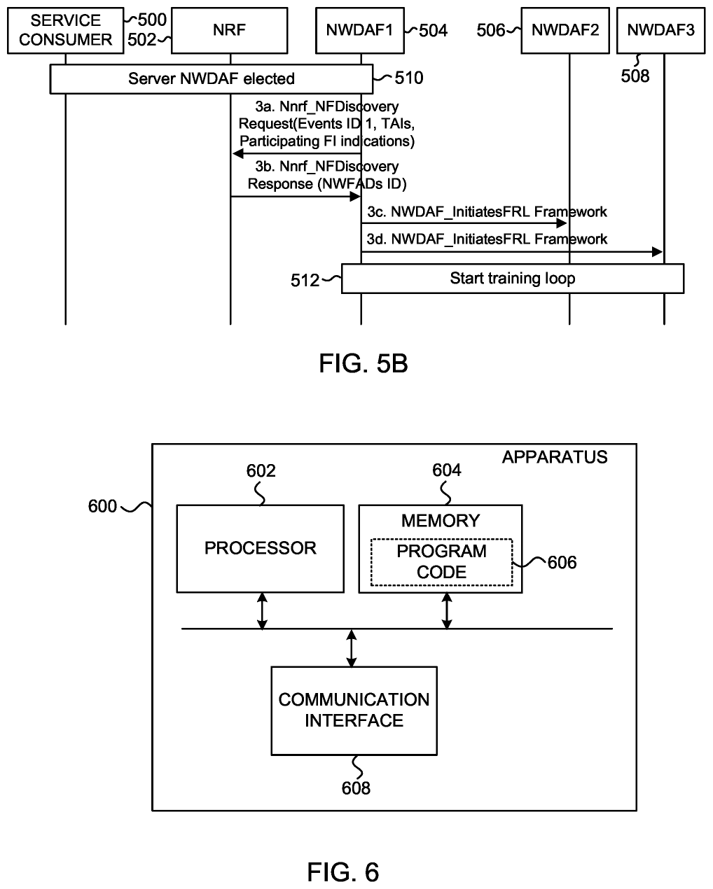

FIG. 6 illustrates an example of an apparatus 600 configured to practice one or more example embodiments. The apparatus 600 may comprise at least one processor 602. The at least one processor 602 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 600 may further comprise at least one memory 604. The at least one memory 604 may be configured to store, for example, computer program code or the like, for example, operating system software and application software. The at least one memory 604 may comprise one or more volatile memory devices, one or more non-volatile memory devices, and/or a combination thereof. For example, the at least one memory 604 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 600 may further comprise a communication interface 608 configured to enable the apparatus 600 to transmit and/or receive information to/from other devices. In one example, the apparatus 600 may use the communication interface 608 to transmit or receive signaling information and data in accordance with at least one data communication or cellular communication protocol. The communication interface 608 may be configured to provide at least one wireless radio connection, such as, for example, a 3GPP mobile broadband connection (e.g. 3G, 4G, 5G, 6G etc.). In another example embodiment, the communication interface 608 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 608 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 600 is configured to implement some functionality, some component and/or components of the apparatus 600, for example, the at least one processor 602 and/or the at least one memory 604, may be configured to implement this functionality. Furthermore, when the at least one processor 602 is configured to implement some functionality, this functionality may be implemented using the program code 606 comprised, for example, in the at least one memory 604.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUs).

The apparatus 600 may comprise means for performing at least one method described herein. In an example embodiment, the means may comprise the at least one processor 602, the at least one memory 604 including program code 606 configured to, when executed by the at least one processor, cause the apparatus 600 to perform the method.

The apparatus 600 may comprise, for example, a computing device, for example, a network server, a network function, a network node, a cloud node or the like. Although the apparatus 600 is illustrated as a single device it is appreciated that, wherever applicable, functions of the apparatus 600 may be distributed to a plurality of devices, for example, to implement example embodiments as a cloud computing service. The apparatus 600 may be configured to perform or cause performance of any aspect of the method(s) described herein. Further, a computer program may comprise instructions for causing, when executed, an apparatus to perform any aspect of the method(s) described herein. The computer program may be stored on a computer-readable medium.

In an example embodiment, the apparatus 600 may implement the features discussed relating to the server network function or the aggregator NWDAF in more detail in any of FIGS. 1A, 2, 3, 5A and 5B and their description. In another example embodiment, the apparatus 600 may implement the features discussed relating to the local network function or the local NWDAF in more detail in any of FIGS. 1B, 2, 4, 5A and 5B and their description.

One or more of the above discussed examples and embodiments may enable a solution for making the system more robust in case of any security attacks or local nodes failure compared to the traditional algorithms. Further, one or more of the above discussed examples and embodiments may decrease latency in the network. Further, one or more of the above discussed examples and embodiments may enable a solution in which there is no need to share data between the local NWDAFs and the aggregator NWDAF, thus resulting in increased privacy for each of the local agents. Instead of sending the local data to the aggregator NWDAF, the illustrated solution performs the main part of the learning process on the edges by the local NWDAFs. To increase the security of the framework, the local NWDAFs may apply the local differential privacy (LDP) mechanism to the gained new parameters of the global model at the end of the training phase. As a consequence of applying the LDP mechanism to the new parameters, the network becomes significantly resistant to the security attacks such as FDIA, phishing attacks and malicious node attacks. Further, one or more of the above discussed examples and embodiments may enable a solution in which the local NWDAFs are in charge of processing the data received from the network functions on the edges and sending the new parameters to the aggregator NWDAF. The aggregator NWDAF then tests the global model based on the new parameters and supervises the local NWDAFs. Consequently, there is no need of having a central server with high computation power and sending these large amounts of data to the central server in each cycle. As a result, the illustrated solution is more energy efficient and less expensive in terms of implementation cost compared to the traditional approaches.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus comprising:
at least one processor; and
at least one memory storing instructions that, when executed by the at least one processor, cause the apparatus at least to perform:
applying, by a server network function, an iterative distributed machine learning model training process between the server network function and at least one local network function, the server network function initially providing the at least one local network function with an initial global machine learning model to be trained by the at least one local network function by respective local data of the at least one local network function;
obtaining, from each local network function of the at least local network function, new parameter data associated with a trained initial global machine learning model trained by each local network function in its latest iteration;
updating the initial global machine learning model at least partly based on the new parameter data obtained from the at least one local network function;
generating, at least partly based on the updated initial global machine learning model, feedback data to the at least one local network function, the feedback data of a local network function reflecting individual performance of the local network function in its latest iteration; and
transmitting the feedback data to the at least one local network function.

2. The apparatus according to claim 1, wherein the instructions, when executed by the at least one processor, cause the apparatus to perform:
transmitting to each local network function of the least one network function an initialization message to start the iterative distributed machine learning model training process, the initialization message transmitted to a local network function comprising encryption parameter data defined for the local network function for encrypting the parameter data sent by the local network function; and
decrypting the new parameter data obtained from a local network function using the encryption parameter data associated with the local network function.

3. The apparatus according to claim 1, wherein the instructions, when executed by the at least one processor, cause the apparatus to perform:
generating after each iteration, at least partly based on individual behaviour of the at least one local network function, weight data associated with the at least one local network function, the weight data providing a weight value for each local network function of the at least one local network function for weighing the new parameter data associated with the local network function.

4. The apparatus according to claim 3, wherein the instructions, when executed by the at least one processor, cause the apparatus to perform:
aggregating the new parameter data obtained from the at least one local network function using weighted federated averaging and the current weight data associated with the at least one local network function.

5. The apparatus according to claim 1, wherein the instructions, when executed by the at least one processor, cause the apparatus to perform:
receiving an evaluation result from each local network function of the at least one local network function, the evaluation result indicating performance of the local network function on its local data; and
using the evaluation results in generating the feedback data.

6. The apparatus according to claim 1, wherein the server network function comprises a network data analytics function.

7. An apparatus comprising:
at least one processor; and
at least one memory storing instructions that, when executed by the at least one processor, cause the apparatus at least to perform:
applying, by a local network function, an iterative distributed machine learning model training process between a server network function and the local network function, an initial global machine learning model being initially obtained from the server network function;
obtaining local data;
obtaining feedback data from the server network function, the feedback data reflecting performance of the local network function in its latest iteration; and
training the initial global machine learning model at least partly based on the feedback data and the local data.

8. The apparatus according to claim 7, wherein the instructions, when executed by the at least one processor, cause the apparatus to perform:
receiving, from the server network function, an initialization message to start the iterative distributed machine learning model training process, the initialization message comprising encryption parameter data defined for the local network function;
obtaining new parameter data associated with the trained initial global machine learning model of the local network function;
encrypting the new parameter data using the encryption parameter data; and
transmitting the encrypted new parameter data to the server network function.

9. The apparatus according to claim 7, wherein the instructions, when executed by the at least one processor, cause the apparatus to perform:
evaluating prediction analytics with the local data to provide an evaluation result; and
transmitting the evaluation result to the server network function.

10. The apparatus according to claim 7, wherein the instructions, when executed by the at least one processor, cause the apparatus to perform:
obtaining new parameter data based on the trained initial global machine learning model; and
transmitting the new parameter data to the server network function.

11. The apparatus according to claim 7, wherein the local network function comprises a network data analytics function.

12. A method comprising:
applying, by a server network function, an iterative distributed machine learning model training process between the server network function and at least one local network function, the server network function initially providing the at least one local network function with an initial global machine learning model to be trained by the at least one local network function by respective local data of the at least one local network function;
obtaining, from each local network function of the at least local network function, new parameter data associated with a trained initial global machine learning model trained by each local network function in its latest iteration;
updating the initial global machine learning model at least partly based on the new parameter data obtained from the at least one local network function;
generating, at least partly based on the updated initial global machine learning model, feedback data to the at least one local network function, the feedback data of a local network function reflecting individual performance of the local network function in its latest iteration; and
transmitting the feedback data to the at least one local network function.

13. The method according to claim 12, further comprising:
transmitting to each local network function of the least one network function, an initialization message to start the iterative distributed machine learning model training process, the initialization message transmitted to a local network function comprising encryption parameter data defined for the local network function for encrypting the parameter data sent by the local network function; and
decrypting the new parameter data obtained from a local network function using the encryption parameter data associated with the local network function.

14. The method according to claim 12, further comprising:
generating, at least partly based on individual behaviour of the at least one local network function, weight data associated with the at least one local network function, the weight data providing a weight value for each local network function of the at least one local network function for weighing the new parameter data associated with the local network function.

15. The method according to claim 14, further comprising:
aggregating the new parameter data obtained from the at least one local network function using weighted federated averaging and the current weight data associated with the at least one local network function.

16. The method according to claim 12, further comprising:
receiving an evaluation result from each local network function of the at least one local network function, the evaluation result indicating performance of the local network function on its local data; and
using the evaluation results in generating the feedback data.

17. The method according to claim 12, wherein the server network function comprises a network data analytics function.

18-24. (canceled)
